(19) United States
(12) Patent Application Publication
(10) Pub. No.: US 2007/0119308 A1
(43) Pub. Date: May 31, 2007

(54) Hot beverage apparatus

(76) Inventors: Dov Z. Glucksman, Danvers, MA (US); Gary P. McGonagle, Lynn, MA (US); John P. Oliver, Salem, MA (US); Laura J. Nickerson, Fitchburg, MA (US)

Correspondence Address: STEVEN A. GARNER, ESQ.;CONAIR CORPORATION, ONE CUMMINGS POINT ROAD, STAMFORD, CT, 06902, US

(21) Appl. No.: 11/600,387

(22) Filed: Nov. 16, 2006

Related U.S. Application Data
(60) Provisional application No. 60/737,344, filed on Nov. 16, 2005.

(51) Int. Cl. A23L 1/00

(52) U.S. Cl. 99/275

(57) ABSTRACT

A hot beverage brewing apparatus 1 has a plurality of heated water delivery nozzles 19 that direct heated water under pressure simultaneously to a specified point 26 within a brew basket 17 that, regardless of the amount or type of grounds in the basket 17, will ensure thorough mixing of the heated water and grounds to deliver optimally brewed beverage. Additionally, the present invention is directed to a heat sensor 31 and weight sensor 33 positioned in contact with a carafe 7 to sense whether or not the carafe is thermally-insulated or not to determine whether or not to automatically activate a warming plate 20.

### CROSS-REFERENCE TO RELATED APPLICATIONS

This application is related to co-pending U.S. application Ser. No. 11/129,041 and it claims priority from U.S. Provisional Application 60/737,344.

### BACKGROUND OF THE INVENTION

1. Field of the Invention

The present invention relates to hot beverage makers such as coffee makers and, more particularly, to hot beverage makers having features that provide optimal brewing performance, and heating efficiency and safety for a brewed beverage.

2. Description of Related Art

Known hot beverage makers of the drip-type have a variety of features and, typically, have the same type of water delivery spout or “shower head” that drips or directs water into a brewing basket and filter assembly. A typical brewing basket holds coffee grounds directly beneath the water delivery spout so that hot water drips into the basket and mixes with the coffee grounds, so that brewed coffee drips out of one or more openings in the bottom of the brewing basket. The rate of water delivery is usually fixed, as is the brewing basket, yet a consumer may choose varying amounts of coffee grounds as well as varying textures and sizes of ground. These factors and others can affect the mixing of the water with the grounds, and thus adversely affect brewing strength and flavor of the resulting brewed beverage. A preferred way for brewing coffee is achieved by using the following method: 1) Placing a predetermined amount of coffee grounds in a conical or basket shape paper filter; 2) Bringing water to a temperature of 90 degree-95 degree C.; 3) delivering water into the coffee grounds at high velocity to obtain a well-mixed slurry of coffee grounds and water; 4) Maintaining a predetermined contact time between water and grounds that is best for the particular type of coffee to ensure the water has extracted the flavorful elements from the coffee, and not the bitter acids.

Other known hot beverage makers usually have either one of a glass carafe for receiving brewed beverage, or a thermally-insulated carafe such as a double-wall carafe for receiving brewed beverage. Typically, the beverage maker has a warming plate located at the base portion where the carafe is placed in order to keep the carafe of freshly-brewed beverage warm. Such a warming plate is not necessary and is ineffective when a thermally-insulated carafe is used. If it is not turned off it is an inefficient use of electrical energy. When a non-insulated carafe is used, the warming plate serves the purpose of maintaining the brewed beverage in a heated condition. While it is known to have manually activated warming plates with hot beverage appliances, such appliances require the user to remember when to turn the plate on or off.

### OBJECTS AND SUMMARY OF THE INVENTION

It is desirable to provide a hot beverage appliance that brews a hot beverage and that overcomes the shortcomings of known appliances discussed above. These and other objects are achieved by the present invention disclosed herein.

The present invention achieves these and other objectives by providing a plurality of heated water delivery nozzles that direct heated water under pressure simultaneously to a specified point within a brew basket that, regardless of the amount or type of grounds in the basket, will ensure thorough mixing of the heated water and grounds to deliver optimally brewed beverage. Additionally, the present invention is directed to a heat sensor positioned in contact with a carafe to sense whether or not the carafe is thermally-insulated or not to determine whether or not to automatically activate a warming plate.

A coffee maker according to the present invention achieves the above-mentioned objectives and others in the following manner: 1) High velocity streams of water help grounds be evenly dispersed in the water for almost the entire brewing process; 2) Water flow is controlled to minimize variation in brewing time from four cups to twelve cups; 3) The brewing temperature remains constant for a major portion of the process; 4) Special sensors prevent over flowing of coffee when carafe is removed; 5) Sensors indicate if an insulated carafe or a glass carafe is used for collecting coffee, controlling whether the stay warm plate should be energized; 6) A sensor prevents more than 10 cups from being brewed if an insulated carafe is being used, due to its smaller capacity; 7) Sensors signal the coffee maker when sufficient water is not available for brewing a pot of coffee.

### BRIEF DESCRIPTION OF THE DRAWINGS

FIG. 1. is an isometric view of a beverage maker according to the present invention.

FIG. 2. is a partial exploded isometric view of the coffee maker in FIG. 1.

FIG. 3. is a schematic, partial cross sectional view of the carafe of a coffee maker according to the invention.

FIG. 4. is a front elevation of the coffee maker of FIG. 1 FIG. 5. is an enlarged view of the control panels of the coffee maker of FIG. 4

FIG. 6. is an enlarged cross section along the lines 8-8 of FIG. 3

FIG. 7. is a cross sectional view of the carafe warming plate of FIG. 3

### DESCRIPTION OF THE PREFERRED EMBODIMENT

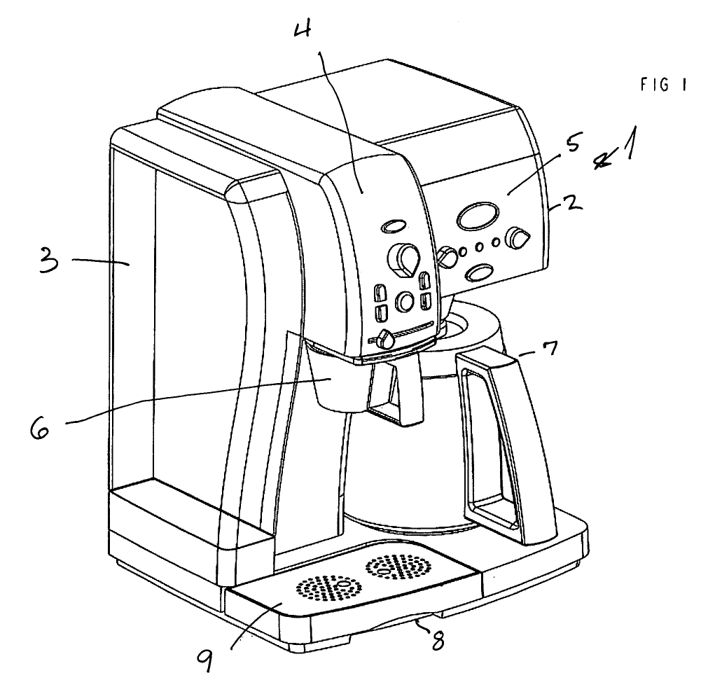

A coffee maker 1 according to the present invention allows a user to choose between brewing a cup at a time through pressurized brewing or brewing a whole pot of coffee through atmospheric brewing (i.e., not pressurized). The coffee brewing apparatus of FIG. 1 includes an enclosure 2, a water container 3, and controls 4, 5 for selecting the type of brew and for turning the coffee maker on and off and for starting the brew cycle. A ground cup 6 is used for brewing a single cup at a time and a carafe 7 is used for receiving the brewed coffee when a pot of coffee is being brewed. Additionally, a drip pan 8 and a drip pan cover 9 are used for supporting one or two cups into which brewed coffee is being dispensed during the pressurized brewing.

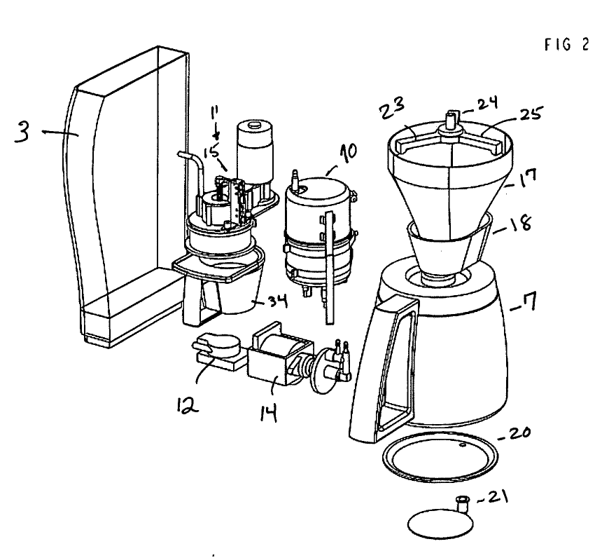

As shown in FIG. 2, the coffee brewing apparatus according to the present invention has components that brew coffee while controlling the amount of coffee and the temperature and flavor of the coffee. An electro mechanical water pump 14, a boiler 10 for heating water and maintaining it at a pre determined temperature, and a flow meter 12 for determining the amount of water that flows through the system of the type generally known are used. A water spreader 13 for delivering water into the coffee filter is shown. A hot water delivery mechanism 11 for brewing coffee under pressure, as well as the gearbox 15 that raises and lowers the water delivery mechanism 11 into and out of the grounds cup 34 is illustrated in FIG. 2. The details of the water delivery mechanism 11 and the gearbox 15 are described in detail in co-pending patent application Ser. No. 11/129,041.

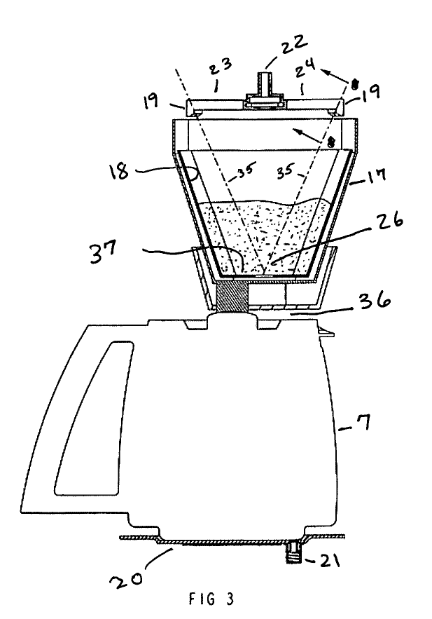

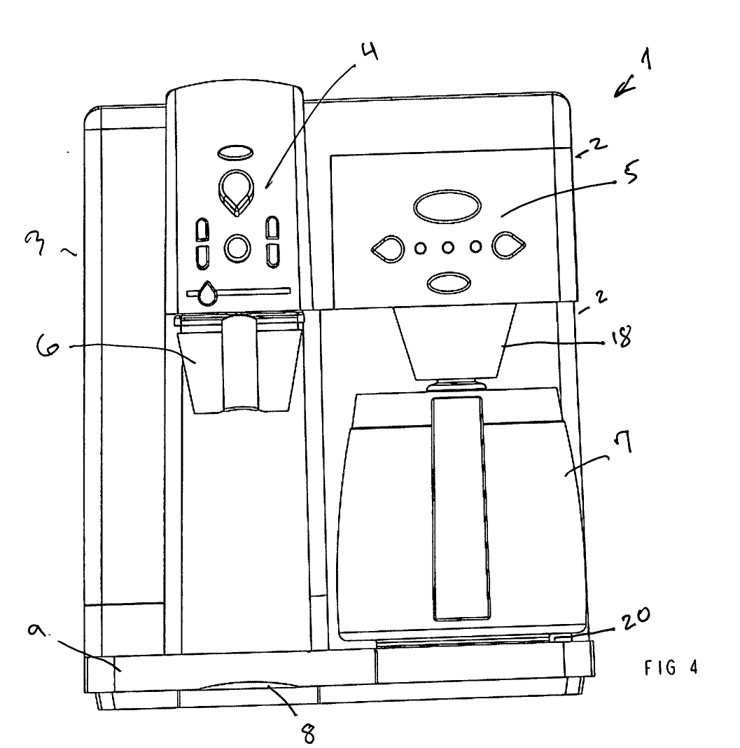

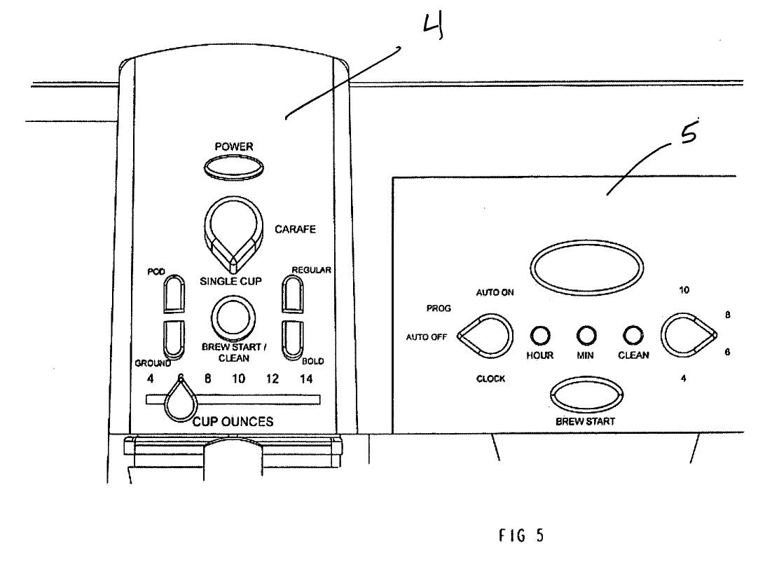

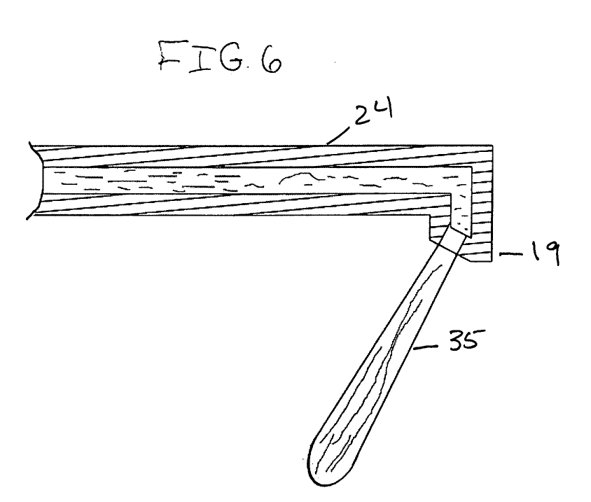

FIG. 3 illustrates components that are relevant to the performance of the atmospheric brewing part of the machine. A schematic outline of a coffee carafe 7 is shown. Situated above the carafe 7 is a filter holder 17 and support 18 for supporting a coffee filter 18, shown in cross section. Above the filter holder 17 is a water spreader 13 shown in partial cross section, with lines 35 that simulate the flow of jets of water out of the water spreader nozzles 19. Underneath the carafe 7 is a warming plate 20 with a spring-loaded sensor 21, which makes contact with the bottom of the carafe 7. The significance of the sensor 21 will become apparent when the performance of the coffee making apparatus 1 is discussed in detail.

The water spreader 13 as shown in consists of a centrally located water supply opening 22 connected through tubing to the outlet of the water boiler. The spreader has three (though another number could suffice) arms 23, 24, 25 in fluid connection to the water inlet. Each arm terminates with a nozzle 19, which is directed so that the jets 35 of water emanating from the nozzle 19 run nearly parallel to the outer walls of the coffee filter 18. The three jets 35 of water meet at a point 26 in space, which is slightly above the base 37 of the filter. By positioning the jets 35 in such a way it is guaranteed that regardless of the amount of coffee grounds placed in the filter 18 the three jets 35 will hit the coffee away from each other, thereby assuring that the coffee/water mixture is well agitated and that the coffee grounds become mixed with the water evenly before exiting through opening 36. This is important to ensure uniform extraction from all the coffee grounds.

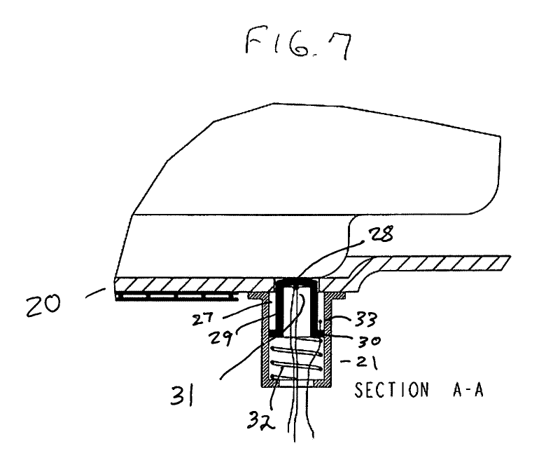

FIG. 7 is an enlarged cross-sectional view of the carafe warming plate 20 according to the invention. It illustrates the sensor 21 located in the warming plate 20. The sensor 21 consists of a cap 27 with a top portion 28, sidewall 29 and a circumferential flange 30. The cap 27 is made of a thermally conductive material such as brass or aluminum. At the top of the cap is a temperature sensor 31 such as an NTC conductively connected to the top of the cap 27. The cap 27 is urged upwards towards the carafe 7 by a spring 32. On the flange is an electrical contact 33, electrically isolated from the flange 30. Both the temperature sensor 31 and the electrical contact 33 are connected to the control circuit (not shown) of the coffee brewing machine 1. The temperature sensor 31 will sense the temperature of the carafe 7 at all times. The electrical contact 33 will close an electrical circuit with the plate 20 when the carafe 7 is lifted from the warming tray as the spring 32 will then urge the cap 27 upwards and the contact will connect to the warming plate 20.

In operation, the user desiring to brew a carafe 7 of coffee turns the coffee maker 1 on. This will signal to the water heater 10 to heat the water in the tank 3 to the appropriate brewing temperature of 90-95 C. The user should check that there is sufficient water in the water container 3. After that, the user places a predetermined amount of ground coffee in the brew-filter 18 (disposable paper filter, or permanent filter) that is in the brew basket 17. Next, the user selects the number of cups desired, by setting the cup indicator 4, 5 to the appropriate number (from 2-12 cups). Thereafter the user selects the desired strength of brew (mild, normal or strong). Thereafter the user starts the brew cycle. Alternatively, the user can set the automatic “on” to the time when the coffee should be ready for consumption.

When the brewing cycle is to commence the following occurs:

1. The electronic controller will determine if there is sufficient water in the water reservoir to brew 12 cups of coffee. If not, a signal (visual and/or audio) will go on alerting the user to add water. (Optionally, a controller could also be employed that determines if the water in the tank is sufficient to brew the number of cups selected).
2. The sensor located at stay warm senses if the carafe is in place.
3. The pump pumps water from the water container into the heated tank and thereby delivers the hot water from the heated tank into the brew basket. As the hot water is displaced from the tank, the cool water will be heated to the preset brewing temperature.
4. The program controls the water delivery rate so that the pre-selected number of cups will be delivered at such a rate that the total brew cycle will remain constant regardless of the number of cups being brewed. That means that if fewer cups are to be brewed the deliver rate shall be slower than if more cups are to be brewed. The water delivery rate can be controlled in a number of ways, for example:
   a. By slowing the pump down.
   b. By cycling the pump on and off.
5. a few minutes after the start of the brew cycle the sensor located in the stay warm plate, and contacting the carafe bottom will be directed to determine:
   a. Is the temperature of the carafe below 50C?
   b. Is the temperature of the carafe above 50C?
6. If the temperature of the carafe is below 50 C. this indicates that the carafe being used is a thermal carafe, as the coffee in it would not heat up the bottom that is insulated from the interior of the carafe. In that case, the stay warm heater will stay off.
7. If the temperature of the bottom of the carafe reads over 50C. then the stay warm heater will go on and will be controlled by the sensor to maintain a coffee temperature of between 75 and 85 C., which is the appropriate temperature for keeping coffee prior to pouring it into cups for consumption.
8. If the user sets the coffee maker to brew 12 cups, and uses a thermal carafe (which has a maximum capacity of 10 cups), the sensor will command the electronic controller to stop the brew cycle after 10 cups to prevent the overflow of coffee, due to the smaller capacity of the thermal carafe.
9. If during the brew cycle the carafe is removed for any reason the sensor will automatically stop the pump from delivering any more water into the brew basket until the carafe is returned to its place. That is done to prevent the overflow of the brew basket, as its outlet will be automatically shut the moment the carafe is removed, by means know in the art as “drip stop”.
10. In order to create a well-mixed slurry in the brew basket the hot water is delivered into the brew basket in three jet streams. Three nozzles, located in the “shower head” above the brew basket, create these jet streams. The nozzles are deigned to direct the jet streams along an angle that runs parallel to the outer walls of the filter, thereby insuring that the water will impact the grounds in the filter at three discrete places regardless of the amount of ground coffee in the filter.
11. The coffee maker will indicate the completion of the brew cycle by a visual and/or audio signal.
12. At the end of the brew cycle, the heater in the tank will turn itself off. Alternatively, it could be commanded to stay on and maintain water in the tank at the brew temperature for an additional predetermined time, and then turn itself off.
13. After another pre-set amount of time, the stay warm heater will turn itself off, as coffee will lose its flavor and turn bitter if kept at a serving temperature for too many hours. A signal (audio or visual) will indicate to the user that the coffee is no longer at the serving temperature.

While a preferred embodiment of the present invention has been described herein, it is understood that various modification can be made without departing from the scope of the present invention.

What is claimed is:

1) A hot beverage making apparatus 1 comprising
a tank 3 for holding liquid;
a heat source 10 for selectively heating said liquid;
a liquid transport system 14 for moving said liquid from said tank to a mixing area 17;
a beverage grounds holder 18 located in said mixing area for holding grounds to be mixed with said water to form a beverage;
a plurality of mixing nozzles 19 for directing pressurized jets 35 of said liquid into said mixing area simultaneously so that said water mixes with said grounds; and
an exit port 36 for delivering said nozzle out of said beverage maker into a container positioned near said exit port.

2) An apparatus according to claim 1, wherein
said grounds holder 18 has a bottom floor portion 37 and said pressurized jets 35 intersect at a location 26 above said floor portion.

3) An apparatus according to claim 1, further comprising
a container supporting plate 20 for supporting said container on said apparatus; and
a weight sensor 33 for sensing the weight of said container.

4) An apparatus according to claim 1, further comprising
a container supporting plate 20 for supporting said container on said apparatus; and
a temperature sensor 31 for sensing the temperature of said container.

5) An apparatus according to claim 3, wherein
said weight sensor 33 communicates with a control circuit of said apparatus to automatically control the volume of beverage being delivered to said container.

6) An apparatus according to claim 4, wherein
said temperature sensor 31 communicates with a control circuit of said apparatus to automatically control a heat element located beneath and in communication with said container.
